(19) United States
(12) Patent Application Publication
(10) Pub. No.: US 2009/0300534 A1
(43) Pub. Date: Dec. 3, 2009

(54) APPARATUS AND METHOD FOR DISPLAYING NETWORK STATUS

(75) Inventors: John Joseph Bush, Bargersville, IN (US); James Edward Harris, Indianapolis, IN (US)

Correspondence Address: BARNES & THORNBURG LLP, 11 SOUTH MERIDIAN, INDIANAPOLIS, IN, 46204, US

(73) Assignee: TRILITHIC, INC., Indianapolis, IN (US)

(21) Appl. No.: 12/469,103

(22) Filed: May 20, 2009

Related U.S. Application Data
(60) Provisional application No. 61/057,375, filed on May 30, 2008.

(51) Int. Cl. G06F 3/14

(52) U.S. Cl. 715/771

(57) ABSTRACT

A method for displaying the status of at least a portion of a CATV system comprises providing a first layer including first geographic indicia, selectively overlaying a second layer including second indicia of the CATV system in a region illustrated in first layer on the first layer, and selectively overlaying a third layer including third indicia of reports of anomalies in the operation of the CATV system equipment in a geographic region illustrated in the first layer. A display thus includes a first layer containing first geographic indicia, a second layer displaying second indicia of the CATV system in the region illustrated in the first layer, and a third layer containing third indicia of reports of anomalies in the operation of the CATV system equipment in the geographic region illustrated in the first layer.

### CROSS REFERENCE TO RELATED APPLICATIONS

This application claims the benefit under 35 U.S.C. §119(e) of the May 30, 2008 filing date of U.S. Ser. No. 61/057,375. The disclosure of U.S. Ser. No. 61/057,375 is hereby incorporated herein by reference.

### FIELD OF THE INVENTION

This invention relates to methods and apparatus for displaying data related to the operation of a CATV system.

### BACKGROUND OF THE INVENTION

Community Antenna Television (hereinafter sometimes CATV or cable) system operators typically have fleets of repair and maintenance vehicles on the road at least during normal business hours, patrolling the cable system (hereinafter sometimes cable plant or CATV plant) in order to maintain it in good repair so that signals supplied to subscribers' facilities, homes and so forth have merchantable quality and so that signals sent upstream in the cable plant are received with sufficient quality to decipher them and act upon them. It is known that various forms of degradation affect these objectives. Noise from various sources internal and external to a subscriber's facility or home can ingress into the cable plant and interfere with signals bound downstream (that is, toward subscribers) or upstream (that is, toward the cable system headend or a cable system hub or node). Equipment, such as line amplifiers, splitters, and the like can malfunction, interfering with signal quality bound downstream, upstream or both.

Among the functions of the cable plant vehicles and operators of the vehicles is obtaining data regarding the operational status of the cable plant. That is, cable plant vehicles are generally equipped with global positioning systems (GPSs), leakage detectors, disk drives with hard disks, and other instruments, in order to ascertain and record geographic locations of the vehicle, measured leakage signal strengths and other system parameters at those locations and times of day, and store the related geographic location and system parameter and time information on the disk or other storage medium. Then, when the vehicle returns, for example, to the head end, hub, or the like, the stored information is uploaded, typically wirelessly directly from the vehicle's memory or by removing a memory card or floppy disk from a vehicle on-board computer, to a cable system server on which is maintained up-to-date cable system status information.

The upshot of this is that there is a large amount of geographically and temporally related information stored on the cable system server(s) regarding cable system operating parameters. There is currently no good way to display this information in any manner that permits observers, for example, cable system maintenance and scheduling personnel, to correlate the geographic and temporal values of all these parameters and geographic and temporal changes in values of all these parameters in (a) way(s) that permit personnel to make judgments about the robustness of the cable system, areas requiring attention, and so on. All of the data are available. They simply cannot be assembled into any kind of meaningful display.

Geographic information systems, also called geographical information systems or geospatial information systems (all collectively hereinafter sometimes GISs), are known. These are systems which permit the capture, storage, analysis and management of data and associated attributes which are spatially referenced to earth.

### DISCLOSURE OF THE INVENTION

According to an aspect of the invention, a display includes a first layer containing first geographic indicia, a second layer overlying the first layer and displaying second indicia of a CATV system in a region illustrated in the first layer, and a third layer containing third indicia of reports of anomalies in the operation of the CATV system equipment in a geographic region illustrated in the first layer.

Illustratively, the display further includes a fourth layer containing first areas displaying recently measured values of a parameter of the CATV system equipment in the region illustrated in the first layer in excess of a first threshold.

Illustratively, the display further includes a fifth layer containing second areas displaying recently measured values of the parameter of the CATV system equipment in the region illustrated in the first layer in excess of a second threshold. The second threshold is greater in absolute magnitude than the first threshold.

Illustratively, the indicia of reports of anomalies in the operation of the CATV system equipment in the region illustrated in first layer include at least one of automatic reports from the CATV system equipment in the region illustrated in the first layer, telephone reports regarding the CATV system equipment in the region illustrated in the first layer, and job reports regarding the CATV system equipment in the region illustrated in the first layer.

Illustratively, the first areas displaying readings of recently measured values of a parameter of the CATV system equipment in the region illustrated in the first layer comprise transparent areas of a first color.

Illustratively, the second areas displaying readings of recently measured values of the parameter of the CATV system equipment in the region illustrated in the first layer comprise transparent areas of a second color.

Illustratively, the first areas showing readings showing recently measured values of a parameter comprise areas showing leakage readings taken during a selectively variable time interval in excess of a first threshold.

Illustratively, the second areas showing leakage readings showing recently measured values of a parameter comprise areas showing leakage readings taken during a selectively variable time interval in excess of a second threshold.

According to an aspect, a method for displaying the status of at least a portion of a CATV system comprises providing a first layer including first geographic indicia, selectively overlaying a second layer including second indicia of the CATV system in a region illustrated in first layer on the first layer, and selectively overlaying a third layer including third indicia of reports of anomalies in the operation of the CATV system equipment in a geographic region illustrated in the first layer.

Illustratively, the method further includes overlaying a fourth layer containing first areas displaying recently measured values of a parameter of the CATV system equipment in the region illustrated in the first layer in excess of a first threshold.

Illustratively, the method further includes overlaying a fifth layer containing second areas displaying recently measured values of the parameter of the CATV system equipment in the region illustrated in the first layer in excess of a second threshold greater in absolute magnitude than the first threshold.

Illustratively, selectively overlaying a third layer including indicia of reports of anomalies in the operation of the CATV system equipment in the region illustrated in the first layer includes selectively overlaying a third layer including indicia of at least one of automatic reports from the CATV system equipment in the region illustrated in the first layer, telephone reports regarding the CATV system equipment in the region illustrated in the first layer, and job reports regarding the CATV system equipment in the region illustrated in the first layer.

Illustratively, overlaying a fourth layer containing first areas displaying recently measured values of a parameter of the CATV system equipment in the region illustrated in the first layer in excess of a first threshold on the third layer comprises overlaying a fourth layer containing first transparent areas of a first color.

Illustratively, overlaying a fifth layer containing second areas displaying recently measured values of the parameter of the CATV system equipment in the region illustrated in the first layer in excess of a second threshold greater in absolute magnitude than the first threshold comprises overlaying a fifth layer containing second transparent areas of a second color.

Illustratively, overlaying a fourth layer containing first areas displaying recently measured values of a parameter of the CATV system equipment in the region illustrated in the first layer in excess of a first threshold on the third layer comprise overlaying a fourth layer containing first areas showing leakage readings taken during a selectively variable time interval in excess of a first threshold.

Illustratively, overlaying a fifth layer containing second areas displaying recently measured values of the parameter of the CATV system equipment in the region illustrated in the first layer in excess of a second threshold greater in absolute magnitude than the first threshold comprises overlaying a fifth layer containing second areas showing leakage readings taken during a selectively variable time interval in excess of a second threshold.

### BRIEF DESCRIPTION OF THE DRAWINGS

The invention may best be understood by referring to the following detailed description and accompanying drawings. In the drawings:

FIG. 1 illustrates a system constructed according to the invention; and, FIG. 2 illustrates an exploded perspective view of the display illustrated in FIG. 1 useful in understanding the invention.

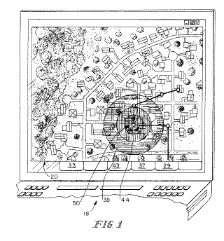

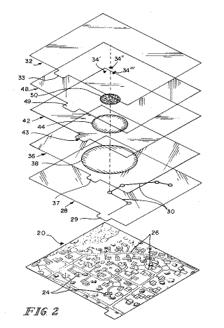

### DETAILED DESCRIPTION OF ILLUSTRATIVE EMBODIMENTS

Various different attributes and parameters of a cable system are displayed on different, otherwise transparent layers of, for example, a physical map overlay, an overlay-like display on a computer monitor, or the like. Each can be selectively overlaid on a street map, topographical map or other type of map which is judged by the user to best display the data being overlaid. Multiple transparent layers can be laid over one another in an established or selectable order to permit correlation of the data contained on selected ones of the transparent layers.

Methods and apparatus are provided for displaying the typically large volume of data a CATV system information database accumulates related to the performance of the CATV system. This information is displayed in a manner which is coherent and readily understandable to, for example, a system analyst, dispatcher or the like. Typically, such a user will have access to a computer monitor 18 display of information related to the performance of the CATV system. On different screens, the user has in the past been call up such data as leakage above a certain level, typically in microvolts per meter (μV/m), reports of dropped telephone calls by those subscribers who use the CATV system for their telephone service, and so on. However, in the past, these facilities were not coordinated. That is, when the user was viewing leakage above a certain threshold value, he or she was viewing a list of measured leakages associated with latitude and longitude coordinates provided, for example, by a global positioning system (GPS). When he or she was viewing dropped calls, he or she was viewing a dropped call report, a list of street addresses and/or telephone numbers of subscribers to this service who had reported dropped calls.

The apparatus and methods integrate all of this information into a useful package for the systems analyst, dispatcher or the like. As an example, assume the monitor 18 displays as a base layer 20 an aerial photograph 20 of a geographic region, such as a neighborhood or the like. This layer 20 contains whatever is in the aerial photograph, dwellings 24, streets 26, and so on. Another layer 28 which the user is capable of selecting by clicking on its tab 29 contains whatever part 30 of the cable plant exists in that geographic region, a so-called “strand map.”

Another layer 32 selectable by the user by clicking on its tab 33 contain indicia 34 of reports, such as automatic reports 34′ from the cable system equipment (line amplifiers, splitters, and so on), telephone reports 34″, job reports 34′″, or the like, from maintenance staff, of anomalies in the operation of the cable system equipment 30 on the section of the strand map represented on the underlying layer 28.

Another layer 36 selectable by the user by clicking on its tab 37 contains transparent areas 38 of a first color, for example, yellow, showing leakage readings taken the last twenty-four hours, thirty days, or some other desired time frame, in excess of a first threshold, say 50 μV/m, 100 μV/m, or some other desired threshold.

Another layer 42 selectable by the user by clicking on its tab 43 contains transparent areas 44 of a second color, for example, orange, showing leakage readings taken the last twenty-four hours, thirty days, or other desired time frame, over a second threshold, say 250 μV/m, 500 μV/m, or some other desired threshold.

The next layer 48 selectable by the user by clicking on its tab 49 contains transparent areas 50 of yet another color, for example, red, showing leakage readings taken in the last twenty-four hours, thirty days, or other desired time frame, over a third threshold, say 1000 μV/m, 2500 μV/m, or some other desired threshold.

The viewer of the display can then readily correlate, for example, known defective equipment, telephone reports of equipment status or parameters, trip reports of equipment status or parameters, and so on, with measured leakage and/or other system anomalies, and use the thus-correlated information to order repairs, and so on.

What is claimed is:

1. A display including a first layer containing first geographic indicia, a second layer overlying the first layer and displaying second indicia of a CATV system in a region illustrated in the first layer, a third layer containing third indicia of reports of anomalies in the operation of the CATV system equipment in a geographic region illustrated in the first layer.

2. The display of claim 1 further including a fourth layer containing first areas displaying recently measured values of a parameter of the CATV system equipment in the region illustrated in the first layer in excess of a first threshold.

3. The display of claim 2 further including a fifth layer containing second areas displaying recently measured values of the parameter of the CATV system equipment in the region illustrated in the first layer in excess of a second threshold, the second threshold greater in absolute magnitude than the first threshold.

4. The display of claim 1 wherein the indicia of reports of anomalies in the operation of the CATV system equipment in the region illustrated in first layer include at least one of automatic reports from the CATV system equipment in the region illustrated in the first layer, telephone reports regarding the CATV system equipment in the region illustrated in the first layer, and job reports regarding the CATV system equipment in the region illustrated in the first layer.

5. The display of claim 2 wherein the first areas displaying readings of recently measured values of a parameter of the CATV system equipment in the region illustrated in the first layer comprise transparent areas of a first color.

6. The display of claim 3 wherein the second areas displaying readings of recently measured values of the parameter of the CATV system equipment in the region illustrated in the first layer comprise transparent areas of a second color.

7. The display of claim 2 wherein the first areas showing readings showing recently measured values of a parameter comprise areas showing leakage readings taken during a selectively variable time interval in excess of a first threshold.

8. The display of claim 3 wherein the second areas showing leakage readings showing recently measured values of a parameter comprise areas showing leakage readings taken during a selectively variable time interval in excess of a second threshold.

9. A method for displaying the status of at least a portion of a CATV system comprising providing a first layer including first geographic indicia, selectively overlaying a second layer including second indicia of the CATV system in a region illustrated in first layer on the first layer, and selectively overlaying a third layer including third indicia of reports of anomalies in the operation of the CATV system equipment in a geographic region illustrated in the first layer.

10. The method of claim 9 further including overlaying a fourth layer containing first areas displaying recently measured values of a parameter of the CATV system equipment in the region illustrated in the first layer in excess of a first threshold.

11. The method of claim 10 further including overlaying a fifth layer containing second areas displaying recently measured values of the parameter of the CATV system equipment in the region illustrated in the first layer in excess of a second threshold greater in absolute magnitude than the first threshold.

12. The method of claim 9 wherein selectively overlaying a third layer including indicia of reports of anomalies in the operation of the CATV system equipment in the region illustrated in the first layer includes selectively overlaying a third layer including indicia of at least one of automatic reports from the CATV system equipment in the region illustrated in the first layer, telephone reports regarding the CATV system equipment in the region illustrated in the first layer, and job reports regarding the CATV system equipment in the region illustrated in the first layer.

13. The method of claim 10 wherein overlaying a fourth layer containing first areas displaying recently measured values of a parameter of the CATV system equipment in the region illustrated in the first layer in excess of a first threshold on the third layer comprises overlaying a fourth layer containing first transparent areas of a first color.

14. The method of claim 11 wherein overlaying a fifth layer containing second areas displaying recently measured values of the parameter of the CATV system equipment in the region illustrated in the first layer in excess of a second threshold greater in absolute magnitude than the first threshold comprises overlaying a fifth layer containing second transparent areas of a second color.

15. The method of claim 10 wherein overlaying a fourth layer containing first areas displaying recently measured values of a parameter of the CATV system equipment in the region illustrated in the first layer in excess of a first threshold on the third layer comprise overlaying a fourth layer containing first areas showing leakage readings taken during a selectively variable time interval in excess of a first threshold.

16. The display of claim 1I1 wherein overlaying a fifth layer containing second areas displaying recently measured values of the parameter of the CATV system equipment in the region illustrated in the first layer in excess of a second threshold greater in absolute magnitude than the first threshold comprises overlaying a fifth layer containing second areas showing leakage readings taken during a selectively variable time interval in excess of a second threshold.
